(19) United States
(12) Patent Application Publication
(10) Pub. No.: US 2005/0020298 A1
(43) Pub. Date: Jan. 27, 2005

(54) Radio communication apparatus and its transmission and reception circuit

(76) Inventors: Hiroshi Masumoto, Yokohama-shi (JP); Tsuneo Suzuki, Kamakura-shi (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/863,469

(22) Filed: Jun. 9, 2004

(30) Foreign Application Priority Data
Jun. 20, 2003 (JP) 2003-176528

(51) Int. Cl. H04B 1/18; H04B 1/10

(52) U.S. Cl. 455/552.1; 455/168.1; 455/188.1

(57) ABSTRACT

A radio communication apparatus includes a first transmission and reception section that executes process of receiving and transmitting a signal with a first frequency band, a second transmission and reception section that executes process of receiving and transmitting a signal with a second frequency band, and a control circuit that sets, in an operation mode, one of the respective transmission and reception sections which uses a frequency band with which a signal is transmitted and received, while setting the other transmission and reception sections in a stop mode.

### CROSS-REFERENCE TO RELATED APPLICATIONS

This application is based upon and claims the benefit of priority from prior Japanese Patent Application No. 2003-176528, filed Jun. 20, 2003, the entire contents of which are incorporated herein by reference.

### BACKGROUND OF THE INVENTION

1. Field of the Invention

The present invention relates to a radio communication apparatus applied to a radio LAN (Local Area Network) system.

2. Description of the Related Art

It is possible to construct a radio LAN system within a limited area so that a plurality of apparatuses can transmit and receive data to and from one another. General radio LANs use the IEEE (Institute of Electrical and Electronics Engineers) 802.11b, which uses a radio frequency band of 2.4 GHz and a transmission rate of 11 Mbps.

However, since the IEEE802.11b uses the transmission rate of 11 Mbps, it requires a long time to transmit contents such as digital video which have a large amount of data. Thus, the IEEE802.11b is unsuitable for streaming.

In recent years, the IEEE802.11a has been standardized, which can provide a higher transmission rate. As a result, a radio LAN system that can provide a transmission rate of 54 Mbps has been put to practical use.

The IEEE802.11a enables the transmission of a large amount of data. However, owing to the use of radio frequency signals with a 5-GHz frequency band, the use of the 64 QAM-OFDM as a modulating method, and the like, IEEE802.11a disadvantageously achieves a short transmission distance. Thus, if a radio communication apparatus is arranged in an area in which radio waves cannot be transmitted or received easily, it cannot carry out data transmissions. In order to solve this problem, a radio communication apparatus has been developed which comprises a radio communication terminal provided not only with a circuit for the IEEE802.11a but also with a circuit for the IEEE802.11b, which achieves a longer transmission distance than the IEEE082.11a. This serves to compensate for the disadvantage of the propagation characteristic of the IEEE802.11a.

A radio communication apparatus used for the IEEE802.11b uses a frequency band of, for example, 300 to 400 MHz for an intermediate frequency (IF) signal. Accordingly, the radio communication apparatus is composed of parts that use a frequency band of 300 to 400 MHz. On the other hand, a radio communication apparatus used for the IEEE802.11a uses, for example, a 500-MHz frequency band for the IF signal. Accordingly, this radio communication apparatus is composed of parts that use a 500-MHz frequency band.

A radio communication terminal using a mixture of the IEEE 802.11b and IEEE802.11a must comprise circuits for the IEEE802.11b and IEEE802.11a, respectively, because these specifications use different parts as described previously. Thus, disadvantageously, the radio communication apparatus is inevitably large-sized and expensive. Further, if circuits with different frequency bands are formed within the same substrate or adjacent to each other, signals from one of the circuits may affect signals from the other.

### BRIEF SUMMARY OF THE INVENTION

A radio communication apparatus according to a first aspect of the present invention includes a first transmission and reception section having a first reception section that receives a first received signal with a first frequency band and a first transmission section that transmits a first transmitted signal with the first frequency band, a second transmission and reception section having a second reception section that receives a second received signal with a second frequency band and a second transmission section that transmits a second transmitted signal with the second frequency band, the second transmission and reception section having the same intermediate frequency as that of the first transmission and reception section, and a control circuit that sets one of the first and second transmission and reception sections in an operation mode and, while setting the other of the first and second transmission and reception sections in a stop mode.

A transmission and reception circuit according to a second aspect of the present invention includes a first transmission and reception section having a first reception section that receives a first received signal with a first frequency band, a first transmission section that transmits a first transmitted signal with the first frequency band, and a first input section to which an external control signal is inputted, and a second transmission and reception section having a second reception section that receives a second received signal with a second frequency band, a second transmission section that transmits a second transmitted signal with the second frequency band, and a second input section to which an external control signal is inputted, the second transmission and reception section having the same intermediate frequency as that of the first transmission and reception section, and wherein the first transmission and reception section sets the first reception section and the first transmission section in an operation mode if a operation control signal is inputted to the first input section, the operation control signal indicating that transmission and reception will be carried out, while setting the first reception section and the first transmission section in a stop mode if a stop control signal is inputted to the first input section, the stop control signal indicating that the transmission and reception will not be carried out, and the second transmission and reception section sets the second reception section and the second transmission section in the operation mode if the operation control signal is inputted to the second input section, while setting the second reception section and the second transmission section in the stop mode if the stop control signal is inputted to the second input section.

### BRIEF DESCRIPTION OF THE SEVERAL VIEWS OF THE DRAWING

FIG. 1 is a block diagram showing essential parts of a circuit configuration in a radio communication apparatus according to a first embodiment of the present invention;

FIG. 2 is a block diagram showing essential parts of a circuit configuration in a radio communication apparatus according to a second embodiment of the present invention;

FIG. 3 is an example of a circuit diagram of a high impedance circuit 41 provided in a 2.4-GHz-band reception circuit 40 in the radio communication circuit shown in FIG. 2;

FIG. 4 is an example of a circuit diagram of a high impedance circuit 43 provided in a 2.4-GHz-band reception circuit 42 in the radio communication circuit shown in FIG. 2; and.

FIG. 5 is a circuit diagram showing an example of a down converter comprising a high impedance circuit.

### DETAILED DESCRIPTION OF THE INVENTION

Embodiments of the present invention will be described below with reference to the drawings.

(First Embodiment)

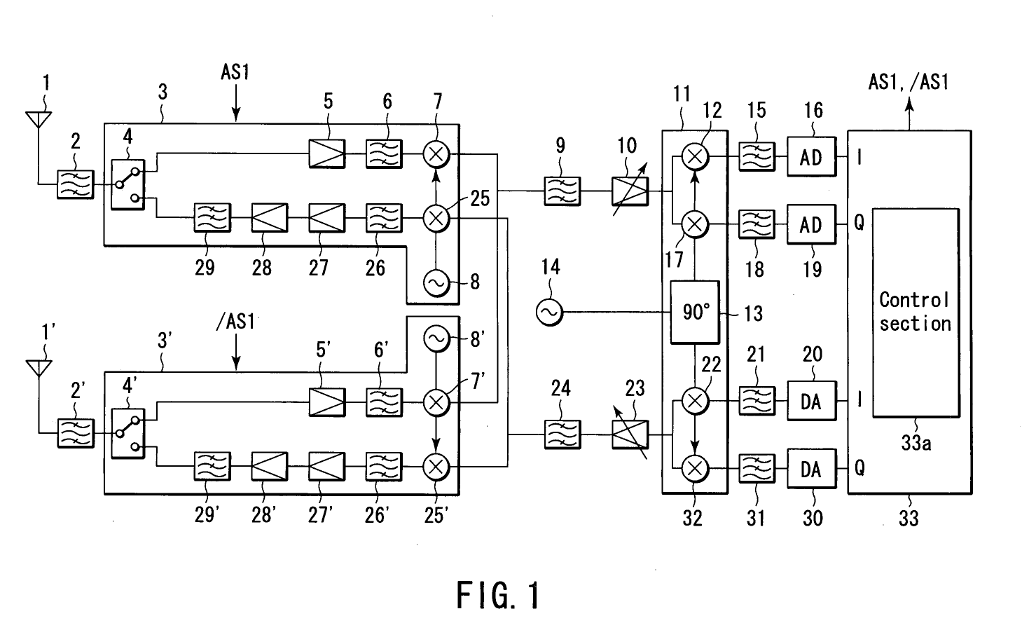

FIG. 1 is a block diagram showing essential parts of a circuit configuration in a radio communication apparatus according to a first embodiment of the present invention.

First, description will be given of the case in which a radio frequency signal with a 2.4-GHz radio frequency band is received. The radio communication apparatus according to embodiments of the present invention uses, for example, 64 QAM (Quadrature Amplitude Modulation) as a modulating method and OFDM (Orthogonal Frequency Division Multiplexing) as a data transmitting method. In FIG. 1, a radio frequency signal with a 2.4-GHz band transmitted by a radio communication apparatus (not shown) is received by an antenna 1 and then passes through an RF (Radio Frequency) filter 2 as a band pass filter. The signal is then inputted to a 2.4-GHz-band transmission and reception circuit 3.

The radio frequency signal inputted to the 2.4-GHz-band transmission and reception circuit 3 is first inputted to a transmission and reception switch 4. The transmission and reception switch 4 is set to a reception side in response to, for example, a control signal from a base band circuit 33. The radio frequency signal outputted by the transmission and reception switch 4 is inputted to a down converter 7 via a receiving LNA (Low Noise Amplifier) 5 and a receiving RF filter 6 as a band pass filter. Further, an RF synthesizer 8 as an oscillator generates a local oscillation signal with a 1.9-GHz band and supplies it to the down converter 7.

The down converter 7 multiplies the inputted radio frequency signal by the local oscillation signal with the 1.9-GHz band supplied by the RF synthesizer 8 to subject these signals to frequency conversion. As a result, an intermediate frequency (IF) signal with a 500-MHz band is obtained. The received IF signal is outputted by the 2.4-GHz-band transmission and reception circuit 3.

The received IF signal outputted by the 2.4-GHz-band transmission and reception circuit 3 passes through a receiving IF filter 9 as a band pass filter. The signal is then inputted to an orthogonal modulation and demodulation circuit 11 via a receiving AGC (Automatic Gain Control) 10. The IF filter 9 is. composed of, for example, an SAW (Surface Acoustic Wave) filter. Further, an IF synthesizer 14 generates a local oscillation signal with a 1000-MHz band, which is double the frequency of the IF signal. The IF synthesizer 14 then inputs this local oscillation signal to the orthogonal modulation and demodulation circuit 11.

The received IF signal inputted to the orthogonal modulation and demodulation circuit 11 is inputted to mixers 12 and 17. Thus, the signal is separated into orthogonal I and Q signals. Specifically, the received IF signal inputted to the mixer 12 is mixed with the local oscillation signal inputted to the orthogonal modulation and demodulation circuit 11 by the IF synthesizer 14. The mixer 12 then outputs the I signal. On the other hand, the received IF signal inputted to the mixer 17 is mixed with the local oscillation signal supplied via a 90° phase shift circuit 13. The mixer 17 then outputs the Q signal. The orthogonal I and Q signals are outputted by the orthogonal modulation and demodulation circuit 11 as orthogonal demodulated signals.

The orthogonal demodulated signals outputted by the orthogonal modulation and demodulation circuit 11 pass through receiving LPFs (Low Pass Filters) 15 and 18, respectively. The signals thus have a band of about 5 MHz. AD converters 16 and 19 then convert the respective orthogonal demodulated signals and then input the converted signals to a base band circuit 33.

Now, description will be given of the case in which a radio frequency signal with a 5-GHz band is received. A radio frequency signal with a 5-GHz band transmitted by a radio communication apparatus (not shown) is received by an antenna 1′ and then passes through a receiving RF filter 2′ as a band pass filter. The signal is then inputted to a 5-GHz-band transmission and reception circuit 3′.

The radio frequency signal inputted to the 5-GHz-band transmission and reception circuit 3′ is first inputted to a transmission and reception switch 4′. The transmission and reception switch 4′ is set to a reception side in response to, for example, a control signal from the base band circuit 33. The radio frequency signal outputted by the transmission and reception switch 4′ is inputted to a down converter 7′ via a receiving LNA (Low Noise Amplifier) 5′ and a receiving RF filter 6′ as a band pass filter. Further, an RF synthesizer 8′ generates a local oscillation signal with a 4.7-GHz band and supplies it to the down converter 7′.

The down converter 7′ multiplies the inputted radio frequency signal by the local oscillation signal with the 4.7-GHz band supplied by the RF synthesizer 8′ to subject these signals to frequency conversion. As a result, an intermediate frequency (IF) signal with the 500-MHz band is obtained as in the case with the 2.4-GHz band. The received IF signal is outputted by the 5-GHz-band transmission and reception circuit 3′.

The received IF signal outputted by the 5-GHz-band transmission and reception circuit 3′ is then inputted to the orthogonal modulation and demodulation circuit 11 via the receiving IF filter 9 as a band pass filter and the receiving AGC (Automatic Gain Control) 10. At this time, the IF synthesizer 14 generates a local oscillation signal with the 1000-MHz band, which is double the frequency of the IF signal. The IF synthesizer 14 then inputs this local oscillation signal to the orthogonal modulation and demodulation circuit 11.

The received IF signal inputted to the orthogonal modulation and demodulation circuit 11 is inputted to mixers 12 and 17. The mixers 12 and 17 performs the previously described operations to separate the received IF signal into orthogonal I and Q signals. These I and Q signals pass through the receiving LPFs 15 and 18, respectively, and thus have a band of about 8 MHz. The AD converters 16 and 19 then convert the I and Q signals into respective digital signals and then input these digital signals to the base band circuit 33.

Now, description will be given of the case in which a radio frequency signal with a 2.4-GHz band is transmitted. DA converters 20 and 30 convert digital I and Q signals, respectively, outputted by the base band circuit 33, into analog I and Q signals. Then, transmitting LPFs 21 and 31 reduce digital noise in the I and Q signals, respectively, and then input them to the orthogonal modulation and demodulation circuit 11.

The I and Q signals inputted to the orthogonal modulation and demodulation circuit 11 are inputted to mixers 22 and 32. The IF synthesizer 14 generates the local oscillation signal with the 100-MHz band and inputs this signal to the orthogonal modulation and demodulation circuit 11 as described above. The mixer 22 mixes the I signal with the local oscillation signal. The mixer 32 mixes the Q signal with the local oscillation signal having its phase shifted by the 90° phase shift circuit 13. Thus, the I and Q signals are modulated into a transmitted IF signal with a 500-MHz band. The output signals from the mixers 22 and 32 are superimposed on each other.

The transmitted IF signal outputted by the orthogonal modulation and demodulation circuit 11 has its gain controlled by a transmitting AGC 23 and passes through a transmitting IF filter 24. The signal is then inputted to the 2.4-GHz-band transmission and reception circuit. The IF filter 24 is composed of, for example, an SAW filter.

The transmitted IF signal inputted to the 2.4-GHz-band transmission and reception circuit 3 is inputted to an up converter 25. The up converter 25 multiplies the transmitted IF signal by a local oscillation signal with a 1.9-GHz band generated by the RF synthesizer 8 to subject these signals to frequency conversion. As a result, a radio frequency signal with the 2.4-GHz band is obtained. A transmitting LPF 26 as a band pass filter, a driver amplifier 27, a power amplifier 28, and a transmitting LPF 29 cooperate in converting the radio frequency signal so that it comprises a predetermined band and a predetermined gain. The converted radio frequency signal is inputted to the transmission and reception switch 4. The transmission and reception switch 4 is set to a transmission side in response to, for example, a control signal from the base band circuit 33. The radio frequency signal outputted by the transmission and reception switch 4 passes through the RF filter 2 and is then transmitted to the air through the antenna 1.

Now, description will be given of the case in which a radio frequency signal with a 5-GHz radio frequency band is transmitted. The DA converters 20 and 30 convert digital I and Q signals, respectively, outputted by the base band circuit 33, into analog I and Q signals. Then, the transmitting LPF 21 and 31 reduce digital noise in the I and Q signals, respectively, and then inputs them to the orthogonal modulation and demodulation circuit 11.

The analog I and Q signals inputted to the orthogonal modulation and demodulation circuit 11 are inputted to mixers 22 and 32. The IF synthesizer 14 generates a local oscillation signal with the 100-MHz band and inputs this signal to the orthogonal modulation and demodulation circuit 11 as described above. The orthogonal modulation and demodulation circuit 11 then performs the previously described operations to modulate the I and Q signals into a transmitted IF signal with a 500-MHz band.

The transmitted IF signal outputted by the orthogonal modulation and demodulation circuit 11 is inputted to the 5-GHz-band transmission and reception circuit 3′ via the transmitting AGC 23 and the transmitting IF filter 24.

The transmitted IF signal inputted to the 5-GHz-band transmission and reception circuit 3′ is inputted to an up converter 25′. The up converter 25′ multiplies the transmitted IF signal by a local oscillation signal with a 4.7-GHz band generated by the RF synthesizer 8′ to subject these signals to frequency conversion. As a result, a radio frequency signal with the 5-GHz band is obtained. A transmitting LPF 26′ as a band pass filter, a driver amplifier 27′, a power amplifier 28′, and a transmitting LPF 29′ cooperate in converting the radio frequency signal so that it comprises a predetermined band and a predetermined gain. The converted radio frequency signal is then inputted to the transmission and reception switch 4′. The radio frequency signal outputted by the transmission and reception switch 4′ passes through the RF filter 2′ and is then transmitted to the air through the antenna 1′.

The base band circuit 33 comprises a typical radio access function, a data transmitting function, a function of selecting a radio frequency band used to communicate with a target apparatus, and other functions. Further, the base band circuit 33 comprises a control section 33a.

The control section 33a switches the 2.4-GHz-band transmission and reception circuit 3 and the 5-GHz-band reception circuit 3′ between an operation mode and a stop mode depending on the frequency band used to transmit and receive data. The control section 33a controls these transmission and reception circuits in a time division manner. In the operation mode, the elements constituting the transmission and reception circuit can transmit and receive data. On the other hand, in the stop mode, for example, the supply of a power voltage to the elements constituting the transmission and reception circuit is stopped. Further, in the stop mode, the elements constituting the transmission and reception circuit do not affect the circuit with the operating frequency.

Description will be given of operations of the radio communication apparatus configured as described above.

It is assumed that the base band circuit 33 selects a frequency band used to transmit and receive data to and from a target apparatus and communicates with this apparatus using, for example, the 5-GHz band. Then, the control section 33a sets a control signal AS1 to a high level. Thus, the 5-GHz-band transmission and reception circuit 3′ is set in the operation mode. At this time, a control signal AS1 supplied to the 2.4-GHz-band transmission and reception circuit 3 is set to a low level. Accordingly, the 2.4-GHz-band transmission and reception circuit 3 is set in the stop mode.

That is, when the control signal /AS1 changes to the low level, the 2.4-GHz-band transmission and reception circuit 3 stops supplying a power voltage to the elements constituting the 2.4-GHz-band transmission and reception circuit 3. Further, when the control signal AS1 changes to the low level, the 5-GHz-band transmission and reception circuit 3′ supplies the power voltage to the elements constituting the 5-GHz-band transmission and reception circuit 3′.

On the other hand, it is assumed that the base band circuit 33 selects a frequency band used to transmit and receive data to and from a target apparatus and communicates with this apparatus using the 2.4-GHz band. Then, the control section 33a sets the control signal AS1 to the low level. Thus, the 5-GHz-band transmission and reception circuit 3′ is set in the stop mode. The 2.4-GHz-band transmission and reception circuit 3 is set in the operation mode.

In the present embodiment, both 2.4-GHz-band transmission and reception circuit 3 and 5-GHz-band transmission and reception circuit 3′ use the 500-MHz frequency band for the intermediate frequency signal. Typically, if the RF ranged from 5.15 to 5.25 GHz, then for example, the IF is selected as a certain point between 500 and 600 MHz. In this case, an RF side synthesizer oscillates in the 4.7-GHz band. An IF side synthesizer oscillates between 1,000 and 1,200 MHz. On the other hand, if the RF is in the 2.4-GHz band, then for example, the IF is selected as a certain point between 300 and 400 MHz. In this case, the RF side synthesizer oscillates between 2.0 and 2.1 GHz. The IF side synthesizer oscillates between 600 and 800 MHz. In this manner, the 5-GHz band and the 2.4-GHz band differ in the IF band.

The IF band depends on the characteristics of the RF filter. The attenuation characteristic of the filter is such that with a quality factor of a resonator remaining unchanged, the filter attenuates more slowly at a higher frequency. Accordingly, if a signal with a high frequency is filtered, an oscillation signal from the RF side synthesizer may leak from the antenna during transmission (this phenomenon will hereinafter be referred to as “local leakage”).

When the frequency of a radio frequency signal transmitted by the antenna is defined as f0, the IF band is defined as f1, and the frequency of the RF synthesizer is defined as fL0, the frequency F0 is can be expressed as follows:
F0=fL0+f1.

Specifically, the frequency fL0 decreases with increasing the frequency band f1: it moves away from the frequency f0. Consequently, the frequency fL0 is outside the band of the RF filter, thus preventing local leakage.

If the 5-GHz band is used to achieve the same amount of local leakage attenuation as that with the 2.4-GHz band, the IF of the 5-GHz band must be double that of the 2.4-GHz band provided that the number of stages in the filter remains unchanged.

In the present embodiment, both the 5-GHz band and the 2.4-GHz band circuits use the same IF, used for the 5-GHz band, to suppress local leakage when a radio frequency signal with the 2.4-GHz band is transmitted.

As described above, according to the present embodiment, in the radio communication apparatus in which a mixture of the 2.4- and 5-GHz bands is used as a radio frequency band, radio frequency signals with the 2.4- and 5-GHz bands, respectively, are processed in a time division manner to avoid the simultaneous operation of the 2.4- and 5-GHz-band transmission and reception circuits 3 and 3′. Furthermore, both circuits use the common frequency band, i.e. the 5-GHz band, for the intermediate frequency (IF) signal.

Therefore, according to the present embodiment, it is possible to share the circuits following the 2.4- and 5-GHz-band transmission and reception circuits 3 and 3′. This sharply reduces the number of parts required, to enable a reduction in the size of the apparatus.

Further, signals with the 2.4- and 5-GHz bands do not simultaneously operate. This eliminates the need for isolation between the 2.4-GHz-band circuit and the 5-GHz-band circuit.

Further, the circuit with the frequency band that is not being operated is set in the stop mode. It is thus possible to reduce the power consumption of a battery or a power source.

In the above embodiment, the control signal AS1 and /AS1, outputted by the base band circuit 33, are inputted to the 2.4- and 5-GHz-band transmission and reception circuits 3 and 3′, respectively. However, for example, each of these control signals may be inputted to each of the elements constituting the 2.4-GHz-band transmission and reception circuit 3. Such a configuration enables such control as maintains elements requiring a long time for activation, in the operation mode.

Alternatively, for example, elements such as the RF synthesizer 8 which require a long time for activation may be allowed to operate at all times, with only the output from the synthesizer stopped. Alternatively, the RF synthesizer 8 may be set in the stop mode, while for example, those of the elements of the synthesizer which require a long time for activation, such as a PLL (Phase Locked Loop), may be allowed to operate.

Alternatively, the 2.4- and 5-GHz-band transmission and reception circuits 3 and 3′ each comprise an input pin to which the control signal AS1 or /AS1 is inputted. In this case, the operation mode or the stop mode is established if the control signal is inputted to this input pin.

Further, the above embodiment comprises the two antennas for the 2.4- and 5-GHz bands, respectively. However, an antenna duplexer may be used to share a single antenna. Such a configuration enables the size of the apparatus to be further reduced.

(Second Embodiment)

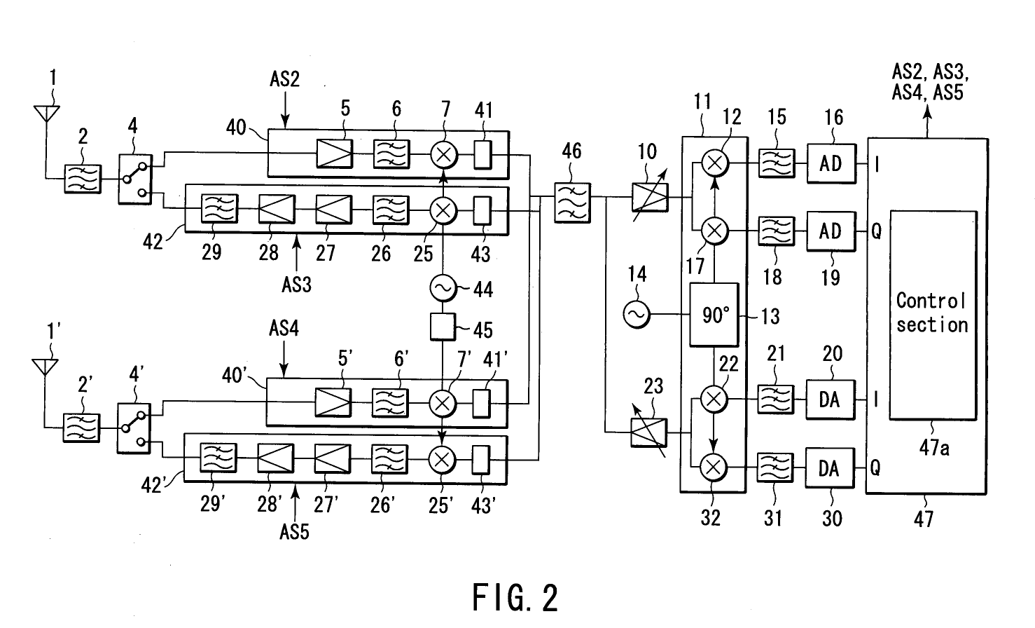

FIG. 2 is a block diagram showing essential parts of a circuit configuration in a radio communication apparatus according to a second embodiment of the present invention. In FIG. 2, the same parts as those in FIG. 1, described above, are denoted by the same reference numerals. Their description is omitted.

Now, description will be given of the case in which a radio frequency signal with the 2.4-GHz radio frequency band is received. The radio frequency signal with the 2.4-GHz band received by the antenna 1 is inputted to a 2.4-GHz-band reception circuit 40 via the transmission and reception switch 4. The radio frequency signal inputted to the 2.4-GHz-band reception circuit 40 is inputted to the down converter 7 as in the case with the first embodiment. Further, an RF synthesizer 44 generates a local oscillation signal of 2.8 to 2.9 GHz. This local oscillation signal is inputted to the down converter 7.

The down converter 7 multiplies the radio frequency signal by the local oscillation signal of 2.8 to 2.9 GHz inputted by the RF synthesizer 44 to subject these signals to frequency conversion. As a result, an IF signal of 400 to 600 GHz is obtained. The 2.4-GHz-band reception circuit 40 outputs the received IF signal via a high impedance circuit 41 that provides a high impedance while it is in the stop mode.

The received IF signal outputted by the 2.4-GHz-band reception circuit 40 passes through an IF filter 46 as a band pass filter and is then inputted the orthogonal modulation and demodulation circuit 11. The IF filter 46 is composed of, for example, an SAW filter.

Description will be given of the case in which a radio frequency signal with the 5-GHz radio frequency band is received. The radio frequency signal with the 5-GHz band received by the antenna 1′ is inputted to a 5-GHz-band reception circuit 40′ via the transmission and reception switch 4′. The radio frequency signal inputted to the 5-GHz-band reception circuit 40′ is inputted to the down converter 7′ as in the case with the first embodiment. Further, the RF synthesizer 44 generates a local oscillation signal of 2.8 to 3 GHz. This local oscillation signal is inputted to a multiplier circuit 45. The multiplier circuit 45 converts the local oscillation signal so as to double its frequency. The converted local oscillation signal is inputted to the down converter 7′.

The down converter 7′ multiplies the radio frequency signal by the local oscillation signal inputted by the multiplier circuit 45 to subject these signals to frequency conversion. As a result, an IF signal of 400 to 600 GHz is obtained. The 5-GHz-band reception circuit 40′ outputs the received IF signal via a high impedance circuit 41′.

The received IF signal outputted by the 5-GHz-band reception circuit 40′ passes through the IF filter 46 and is then inputted the orthogonal modulation and demodulation circuit 11.

Now, description will be given of the case in which a radio frequency signal with the 2.4-GHz radio frequency band is transmitted.

A transmitted IF signal outputted by the orthogonal modulation and demodulation circuit 11 passes through the IF filter 46 and is then inputted to a 2.4-GHz-band transmission circuit 42.

The transmitted IF signal inputted to the 2.4-GHz-band transmission circuit 42 is inputted to the up converter 25 via a high impedance circuit 43. The up converter 25 multiplies the transmitted IF signal by a local oscillation signal of 2.8 to 2.9 GHz generated by the RF synthesizer 8 to subject these signals to frequency conversion. As a result, a radio frequency signal with the 2.4-GHz band is obtained. This radio frequency signal is transmitted to the air through the antenna 1.

Now, description will be given of the case in which a radio frequency signal with the 5-GHz radio frequency band is transmitted. A transmitted IF signal outputted by the orthogonal modulation and demodulation circuit 11 passes through the IF filter 46 and is then inputted to a 5-GHz-band transmission circuit 42′.

The transmitted IF signal inputted to the 5-GHz-band transmission circuit 42′ is inputted to the up converter 25′ via a high impedance circuit 43′. The up converter 25′ multiplies the transmitted IF signal by a local oscillation signal generated by the multiplier circuit 45 to subject these signals to frequency conversion. As a result, a radio frequency signal with the 5-GHz band is obtained. This radio frequency signal is transmitted to the air through the antenna 1′.

The base band circuit 47 comprises a typical radio access function, a data transmitting function, a function of selecting a radio frequency band used to communicate with a target apparatus, and other functions. Further, the base band circuit 47 comprises a control section 47a.

The control section 47a switches the 2.4-GHz-band reception circuit 40, the 2.4-GHz-band transmission circuit 42, the 5-GHz-band reception circuit 40′, and the 5-GHz-band transmission circuit 42′ between the operation mode and the stop mode depending on the frequency band used to transmit and receive data.

Description will be given of operations of the radio communication apparatus configured as described above.

It is assumed that the base band circuit 47 selects a frequency band used to transmit and receive data to and from a target apparatus and communicates with this apparatus using, for example, the 5-GHz band. Then, the control section 47a sets a control signal AS4 to the high level and the other control signals AS2, AS3, and AS5 to the low level in order to set the 5-GHz-band reception circuit 40′. The control signal AS4 is supplied to the 5-GHz-band reception circuit 40′. Further, the control signals AS2, AS3, and AS5 are supplied to the 2.4-GHz-band reception circuit 40, the 2.4-GHz-band transmission circuit 42, and the 5-GHz-band transmission circuit 42′, respectively.

When the control signal AS4 changes to the high level, the 5-GHz-band transmission and reception circuit 40′ supplies the power voltage to the elements constituting the 5-GHz-band transmission and reception circuit 40′. On the other hand, when the control signal AS5 changes to the low level, the 5-GHz-band transmission and reception circuit 40′ stops supplying the power voltage to the elements constituting the circuit. This also applies to the 2.4-GHz-band reception circuit 40 and the 2.4-GHz-band transmission circuit 42.

In the present embodiment, the IF filter 46, a filter for the intermediate frequency, is shared by the 5- and 2.4-GHz bands. This is accomplished by providing the high impedance circuit in each transmission and reception circuit. The high impedance circuit will be described below.

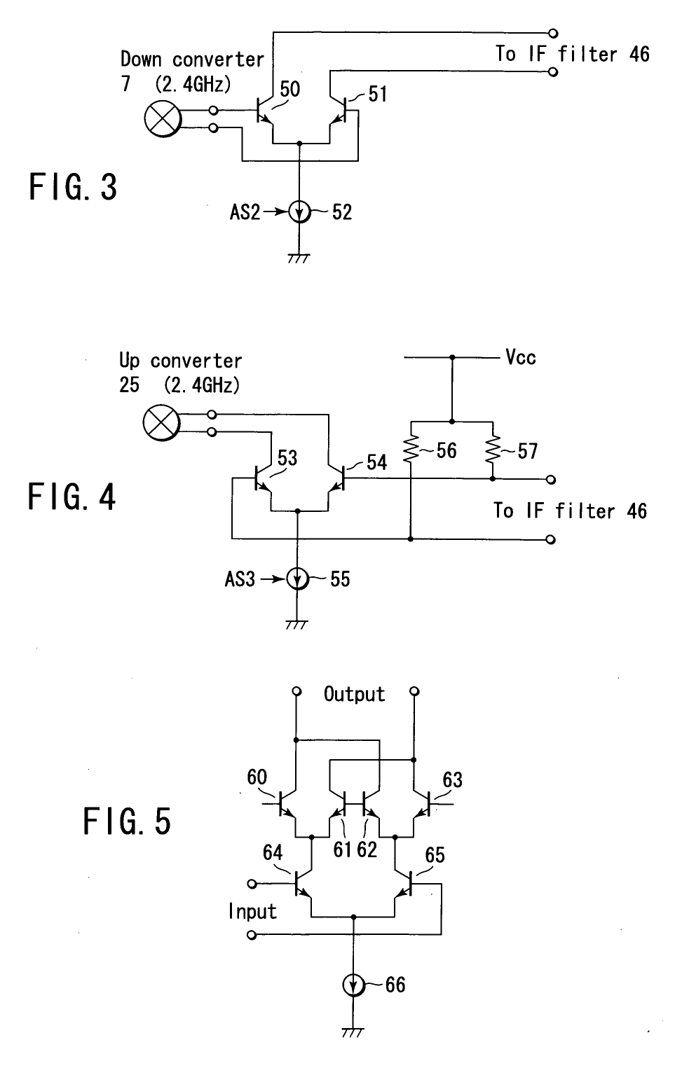

FIG. 3 is an example of a circuit diagram of the high impedance circuit 41, provided in the 2.4-GHz-band reception circuit. The high impedance circuit 41 is composed of transistors 50 and 51 and a constant current circuit 52. When the 2.4-GHz-band reception circuit 40 is set in the stop mode, the supply of the power voltage to the constant current circuit 52 is stopped. The supply of the power voltage is stopped by for example, supplying the control signal AS2 to the constant current circuit 52. Then, the 2.4-GHz-band reception circuit 40 has a high impedance with respect to the IF filter 46. Additionally, the configuration of the high impedance circuit 41′, provided in the 5-GHz-band reception circuit 40′, is similar to that of the high impedance circuit 41. Its description is thus omitted.

Now, description will be given of the high impedance circuit 43, provided in the 2.4-GHz-band transmission circuit 42. FIG. 4 is an example of a circuit diagram of the high impedance circuit 43. The high impedance circuit 43 is composed of transistors 53 and 54, a constant current circuit 55, and resistors 56 and 57. One terminal of each of the resistors 56 and 57 is connected to the power voltage (Vcc). When the 2.4-GHz-band transmission circuit 42 is set in the stop mode, the supply of the power voltage to the constant current circuit 55 is stopped. The supply of the power voltage is stopped by for example, supplying the control signal AS3 to the constant current circuit 55. Then, the 2.4-GHz-band reception circuit 42 has a high impedance with respect to the IF filter 46. Additionally, the configuration of the high impedance circuit 43′, provided in the 5-GHz-band reception circuit 42′, is similar to that of the high impedance circuit 43. Its description is thus omitted.

In a transmitting or receiving operation using the same frequency band, the transmission and reception circuits other than the one operated have a high impedance with respect to the IF filter 46. Accordingly, the IF filter 46 can easily carry out impedance matching and thus has improved characteristics.

In this regard, the separate high impedance circuits may not be provided but the up converters 7 and 7′ or the down converters 25 and 25′ may each be provided with a high impedance circuit. FIG. 5 is a circuit diagram showing an example of a down converter comprising a high impedance circuit. This down converter is composed of transistors 60, 61, 62, 63, 64, and 65 and a constant current circuit 66. In the stop mode, the supply of the power voltage to the constant current circuit 66 is stopped. Then, the down converter has a high impedance with respect to the IF filter 46. The thus configured down converter need not be provided with an additional high impedance circuit. This simplifies the circuit configuration and enables a reduction in the size of the circuit. The up converter has a configuration similar to that in FIG. 5. Accordingly, its description is omitted.

Furthermore, in the present embodiment, the RF side synthesizer is used for both 2.4- and 5-GHz bands. The frequency of the RF synthesizer 44 is defined as fL0, the frequency of the IF is defined as fIF, and the upper side is defined as a local side. Then, the relation between the frequencies fL0 and fIF is can be expressed as follows:

$$fL0 = ( 5.2 - GHz + fIF ) / 2 \\ = 2.4 - GHz + fIF .$$

The upper equation indicates that if the frequency fIF ranges from 400 to 600 MHz, then the frequency fL0 ranges from 2.8 to 2.9 GHz. The lower equation indicates that if the frequency fIF ranges from 400 to 600 MHz, then the frequency fL0 ranges from 2.8 to 3 GHz. Thus, the frequency fL0 has almost the same value in the 5-GHz band and in the 2.4-GHz band. The use of the multiplier circuit 45 for doubling allows the RF side synthesizer to be shared.

At this time, a smaller value of the frequency fIF allows the synthesizer to be shared more easily. However, a smaller value of the frequency fIF may result in more local leakage in the 5-GHz band. In the present embodiment, however, the frequency of the RF synthesizer 44 is half the frequency inherently required for the 5-GHz band. The frequencies inputted to the down converter 7′ and the up converter 25′ are in the 5.6-GHz band if the IF is 400 MHz. However, the RF synthesizer 44 oscillates at a frequency in a 2.8-GHz band, which is sufficiently away from the 5.6-GHz band. Therefore, no problems occur.

As described above, according to the present embodiment, in the radio communication apparatus in which a mixture of the 2.4- and 5-GHz bands is used as a radio frequency band, radio frequency signals with the 2.4- and 5-GHz bands, respectively, are processed in a time division manner. A transmission and a reception using the same frequency band are also processed in a time division manner. Moreover, the local oscillation signal oscillated by RF synthesizer for the 2.4-GHz band is used as an RF side local oscillation signal for the 5-GHz band via the multiplier circuit 45. Further, each transmission and reception circuit comprises a high impedance circuit. Therefore, the present embodiment can produce effects similar to those of the first embodiment.

Furthermore, since the RF synthesizer can be shared, it is possible to reduce the number of parts required and the sizes of the circuits.

Moreover, since a transmission and a reception are processed in a time division manner and each transmission and reception circuit comprises a high impedance circuit, the IF side filter can be shared to reduce further the number of parts required and the sizes of the circuits.

Further, it is possible to apply the arrangement of the second embodiment comprising the multiplier circuit 45 and allowing the RF synthesizer to be shared, to the first embodiment.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

1. A radio communication apparatus comprising:
a first transmission and reception section having a first reception section that receives a first received signal with a first frequency band and a first transmission section that transmits a first transmitted signal with the first frequency band;
a second transmission and reception section having a second reception section that receives a second received signal with a second frequency band and a second transmission section that transmits a second transmitted signal with the second frequency band, the second transmission and reception section having the same intermediate frequency as that of the first transmission and reception section; and
a control circuit that sets one of the first and second transmission and reception sections in an operation mode and, while setting the other of the first and second transmission and reception sections in a stop mode.

2. The radio communication apparatus according to claim 1, wherein the first reception section comprises a first down converter that converts the first received signal into a first signal with the intermediate frequency band,
the first transmission section comprises a first up converter that converts the first signal into the first transmitted signal,
the second reception section comprises a second down converter that converts the second received signal into the first signal, and
the second transmission section comprises a second up converter that converts the first signal into the second transmitted signal.

3. The radio communication apparatus according to claim 2, wherein the first transmission and reception section comprises a first oscillator that generates a first local oscillation signal,
the first down converter converts the first received signal into the first signal on the basis of the first local oscillation signal,
the first up converter converts the first signal into the first transmitted signal on the basis of the first local oscillation signal,
the second transmission and reception section comprises a second oscillator that generates a second local oscillation signal that is different from the first local oscillation signal,
the second down converter converts the second received signal into the first signal on the basis of the second local oscillation signal, and
the second up converter converts the first signal into the second transmitted signal on the basis of the second local oscillation signal.

4. The radio communication apparatus according to claim 3, further comprising:
a demodulation circuit that demodulates the first signal supplied by the first or second reception section; and
a modulation circuit that modulates an input signal into the first signal.

5. The radio communication apparatus according to claim 4, further comprising:
a third oscillator that generates a third local oscillation signal; and
a phase shifter that shifts a phase of the third local oscillation signal through 90°, and
wherein the demodulation circuit has a first mixer that generates an I signal from the first signal on the basis of the third local oscillation signal, and
a second mixer that generates a Q signal from the first signal on the basis of a signal supplied by the phase shifter, and
the demodulation circuit has a third mixer that generates the first signal from the I signal on the basis of the third local oscillation signal supplied by the third oscillator, and
a fourth mixer that generates the first signal from the Q signal on the basis of the signal supplied by the phase shifter.

6. The radio communication apparatus according to claim 2, further comprising a fourth oscillator that generates a fourth local oscillation signal; and
a multiplier circuit that multiplies the fourth local oscillation signal, and
wherein the fourth local oscillation signal is supplied to the first down converter and the first up converter, and an output signal from the multiplier circuit is supplied to the second down converter and the second up converter.

7. The radio communication apparatus according to claim 6, wherein the multiplier circuit generates a local oscillation signal having a frequency band that is double that of the fourth local oscillation signal.

8. The radio communication apparatus according to claim 1, wherein the control circuit provides control such that one of the first transmission section, the first reception section, the second transmission section, and the second reception section is set in the operation mode, while the other sections are set in the stop mode.

9. The radio communication apparatus according to claim 8, further comprising a filter circuit connected both between the demodulation circuit and both first and second reception sections and between the modulation circuit and both first and second transmission section.

10. The radio communication apparatus according to claim 9, further comprising:
a first high impedance circuit connected between the first down converter of the first reception section and the filter circuit and having a high impedance in the stop mode;
a second high impedance circuit connected between the second down converter of the second reception section and the filter circuit and having a high impedance in the stop mode;
a third high impedance circuit connected between the first up converter of the first transmission section and the filter circuit and having a high impedance in the stop mode; and
a fourth high impedance circuit connected between the second up converter of the second transmission section and the filter circuit and having a high impedance in the stop mode.

11. The radio communication apparatus according to claim 1, the plurality of frequency bands include a 2.4-GHz frequency band and a 5-GHz frequency band.

12. A transmission and reception circuit comprising:
a first transmission and reception section having a first reception section that receives a first received signal with a first frequency band, a first transmission section that transmits a first transmitted signal with the first frequency band, and a first input section to which an external control signal is inputted; and
a second transmission and reception section having a second reception section that receives a second received signal with a second frequency band, a second transmission section that transmits a second transmitted signal with the second frequency band, and a second input section to which an external control signal is inputted, the second transmission and reception section having the same intermediate frequency as that of the first transmission and reception section, and
wherein the first transmission and reception section sets the first reception section and the first transmission section in an operation mode if a operation control signal is inputted to the first input section, the operation control signal indicating that transmission and reception will be carried out, while setting the first reception section and the first transmission section in a stop mode if a stop control signal is inputted to the first input section, the stop control signal indicating that the transmission and reception will not be carried out, and
the second transmission and reception section sets the second reception section and the second transmission section in the operation mode if the operation control signal is inputted to the second input section, while setting the second reception section and the second transmission section in the stop mode if the stop control signal is inputted to the second input section.

13. The transmission and reception circuit according to claim 12, wherein the first reception section comprises a first down converter that converts the first received signal into a first signal with the intermediate frequency band,
the first transmission section comprises a first up converter that converts the first signal into the first transmitted signal,
the second reception section comprises a second down converter that converts the second received signal into the first signal, and
the second transmission section comprises a second up converter that converts the first signal into the second transmitted signal.

14. The transmission and reception circuit according to claim 13, wherein the first transmission and reception section comprises a first oscillator that generates a first local oscillation signal,
the first down converter converts the first received signal into the first signal on the basis of the first local oscillation signal,
the first up down converter converts the first signal into the first transmitted signal on the basis of the first local oscillation signal,
the second transmission and reception section comprises a second oscillator that generates a second local oscillation signal that is different from the first local oscillation signal,
the second down converter converts the second received signal into the first signal on the basis of the second local oscillation signal, and
the second up converter converts the first signal into the second transmitted signal on the basis of the second local oscillation signal.
